(19) United States
(12) Patent Application Publication
(10) Pub. No.: US 2011/0108332 A1
(43) Pub. Date: May 12, 2011

(54) Dual-Sprocket Track Drive

(75) Inventor: Keith E. Gleasman, Rochester, NY (US)

(73) Assignee: TORVEC, INC., Rochester, NY (US)

(21) Appl. No.: 12/938,622

(22) Filed: Nov. 3, 2010

Related U.S. Application Data
(60) Provisional application No. 61/260,542, filed on Nov. 12, 2009.

(51) Int. Cl. B62D 11/10

(52) U.S. Cl. 180/6.7

(57) ABSTRACT

A drive for a tracked vehicle supported by a pair of sprocket-driven tracks that receive divided drive torque from the vehicle engine includes a pair of track differentials that are each associated, respectively, with one of the tracks. Each track includes two separate drive sprockets located, preferably, at the front and rear of the track, and the divided torque delivered to each track differential is further divided between the respective front and rear drive sprockets of each track. The track differentials maintain track wrap about the drive sprockets so that drive torque and spike-like forces generated by the momentary loosening and tightening of the track in response to variations in the terrain are shared between an optimal number of drive sprocket teeth at all times. Drive and shock loads borne by the track lugs are significantly reduced and track life is significantly increased.

### REFERENCE TO RELATED APPLICATIONS

This application claims one or more inventions which were disclosed in Provisional Application No. 61/260,542, filed Nov. 12, 2009, entitled “DUAL-SPROCKET TRACK DRIVE”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of tracked vehicles. More particularly, the invention pertains to arrangements for driving the respective tracks of such vehicles.

2. Description of Related Art

For heavily loaded tracked vehicles, such as large tractors and military tanks, engine power is separately delivered to respective left and right endless tracks for driving the vehicle. The tracks are, respectively, positioned in loops along the sides of the vehicle, each track being wrapped beneath at least three or more load-bearing wheels, and each track being individually driven by means of a single drive sprocket often located near either the forward end or rearward end of the track loop. The end of the looped track opposite from the drive sprocket is often provided with balancing support in the form of an idler wheel. For heavy tracked vehicles, the drive sprockets have teeth that engage mating lugs formed within the tracks.

To compensate for changes in track tension when the vehicle is travelling over uneven terrain, most track suspensions provide a hydraulic or spring-biased tensioning apparatus that is associated with an idler wheel positioned under the portion of the track being supported for movement above the tops of the wheels. During normal operations over level terrain, the loads carried by the sprocket teeth and track lugs are quite large and, even with the just-mentioned track tension compensation, the tension on the tracks loosens and tightens.

The loosening and tightening of the tracks is particularly evident when the vehicle is pivot turning. The forward-moving track is taut at the rear of the track but has considerable slack at the front of the track loop, while the backward-moving track is taut at the front of the track but has considerable slack at the rear of the track loop. Even with the just-mentioned track tension compensation, this same tightening and loosening occurs, to a lesser extent, on all turning motions of tracks. Such momentary loosening and tightening of the track subjects the sprocket teeth and track lugs to shock loads that, particularly during operations over rough terrain, can be quite severe.

Consequently, since the beginning of the twentieth century (i.e., for more than 100 years), the single-sprocket driven tracks of heavy tracked vehicles such as tractors and tanks have often become damaged or disabled after relatively few miles of operation and, historically, are well known to experience a very short operational life. Presently, heavy tracked vehicles such as commercial bulldozers and modern military tanks, including, for example, the M2 Bradley infantry fighting vehicle (BAE Systems Land and Armaments, Arlington, Va., USA), the M1A1/M1A2 Abrams Main Battle Tank (Lima Army Tank Plant, Lima, Ohio, USA), the Kodiak armored engineer vehicle (Rheinmetall AG, Duesseldorf, Germany), the Challenger 2 tank (Alvis Vickers LTD, Telford, Shropshire, UK), the Indian Defense Research and Development Organization (DRDO) Arjun tank, the GIAT Leclerc battle tank (Giat Industries S.A., Versailles France), the HIT A1 Khalid (Pakistan)/Type 9041 (China)/MBT 2000 (China) tank, the PT-91 Twardy battle tank (Bumar Labedy, Gliwice, Poland), the ROTEM K2 battle tank (Hyundai Rotem, Changwon-City, South Korea), the T-90 Main Battle Tank (Uralvagonzavod, Nizhny Tagil, Russia), and the Type 99 tank (Norinco, Beijing, China), use such single-sprocket drives for their respective tracks, and such tanks share serious problems caused by the short life of their tracks.

As disclosed in U.S. Pat. No. 6,135,220, entitled “MODULAR SYSTEM FOR TRACK-LAYING VEHICLE”, issued Oct. 24, 2000 to Gleasman et al., incorporated by reference herein, a new track suspension was made public by Torvec, Inc., the assignee of the present application. That suspension had been developed following extensive testing of several prototypes. The tracks of that Torvec suspension are not sprocket driven but rather are driven only by friction between the track and the drive wheels. Initially, the frictional drive was limited to a drive wheel at one end of each track. However, U.S. Pat. No. 6,135,220 discloses a frictional drive preferably divided between front and rear drive wheels for each track, and left and right track differentials used to compensate for speed differences between the front and rear drive wheels of each track during vehicle operation.

### SUMMARY OF THE INVENTION

A drive for a tracked vehicle that is supported by a pair of sprocket-driven tracks delivers divided drive torque from the vehicle engine to a pair of track differentials that are each associated, respectively, with one of the tracks. Each track includes two separate drive sprockets located, preferably, at the front and rear of the track, and the divided torque delivered to each track differential is further divided between the respective front and rear drive sprockets of each track. This latter differentiation maintains track wrap about the drive sprockets so that the drive torque and the spike-like forces generated by the momentary loosening and tightening of the track in response to variations in the terrain are shared between an optimal number of drive sprocket teeth at all times. Thus, drive and shock loads that must be borne by the track lugs are significantly reduced and track life is significantly increased.

The track drive provides a significant improvement in track life by an alteration in the delivery of engine power to each track. Namely, the drive load shared by the track lugs is reduced by 50% by providing a second drive sprocket, and the engine drive to each track is divided between the two drive sprockets. Preferably, the additional second sprocket replaces the balancing idler wheel mentioned above, and the two sprockets are located, respectively, at the front and rear of each track loop so that one sprocket is pulling the track at the same time that the other sprocket is pushing the track under all driving conditions. Although this additional drive sprocket may appear redundant, it reduces the drive load on the track lugs by 50%, while also increasing the efficiency of track operation.

The track drive preferably delivers conventionally-divided “left” and “right” engine outputs from a drive differential to two additional respective left and right “track” differentials that further divide the engine power between the front and rear drive sprockets of each respective track. The respective track differentials reduce “wind-up” from rotational speed differences between the front and rear drive sprockets that may arise from variations in track tension during vehicle operation.

### BRIEF DESCRIPTION OF THE DRAWINGS

FIG. 1 shows a schematic side view of a tracked vehicle with a track drive in an embodiment of the present invention.

FIG. 2 shows a schematic top view of the tracked vehicle of FIG. 1, taken generally along the plane 2-2 of FIG. 1.

FIG. 3A shows a schematic side view of the track of FIG. 1 when travelling over uneven terrain beneath the forward end of the track.

FIG. 3B shows a schematic side view of the track of FIG. 1 when travelling over uneven terrain beneath the rearward end of the track.

### DETAILED DESCRIPTION OF THE INVENTION

There are long-standing problems associated with prior art sprocket-driven track drives. The track drive disclosed herein addresses those problems and provides a significant increase in useful track life.

This track drive not only reduces part fatigue and wear, but also, in effect, doubles safety factors relating to overloads of the track drive. Further, the track drive provides redundancy that may permit operation of the vehicle even in the event that the drive from one of the sprockets is lost. In this regard, one embodiment of the invention uses an all-gear limited-slip differential for each “track” differential.

In preferred embodiments, the dual-sprocket track drive is used on relatively heavy tracked vehicles, including, but not limited to, tractors, tanks, and bulldozers, and, as used herein, “tracked vehicles” refers to vehicles using one or more tracks rather than individual wheels to contact the terrain.

The track drive includes differentials that are preferably conventional “open” differentials but may alternatively be “limited-slip” differentials. Where limited-slip differentials are selected, all-gear limited-slip differentials with crossed-axes are preferred, including, but not limited to, those discussed in U.S. Pat. No. 6,783,476 and U.S. Pat. No. 7,540,821, which are hereby incorporated by reference herein. By using such a limited-slip differential in place of a conventional open differential, in the event that one damaged drive sprocket should begin to slip, the other drive sprocket may continue to carry the load.

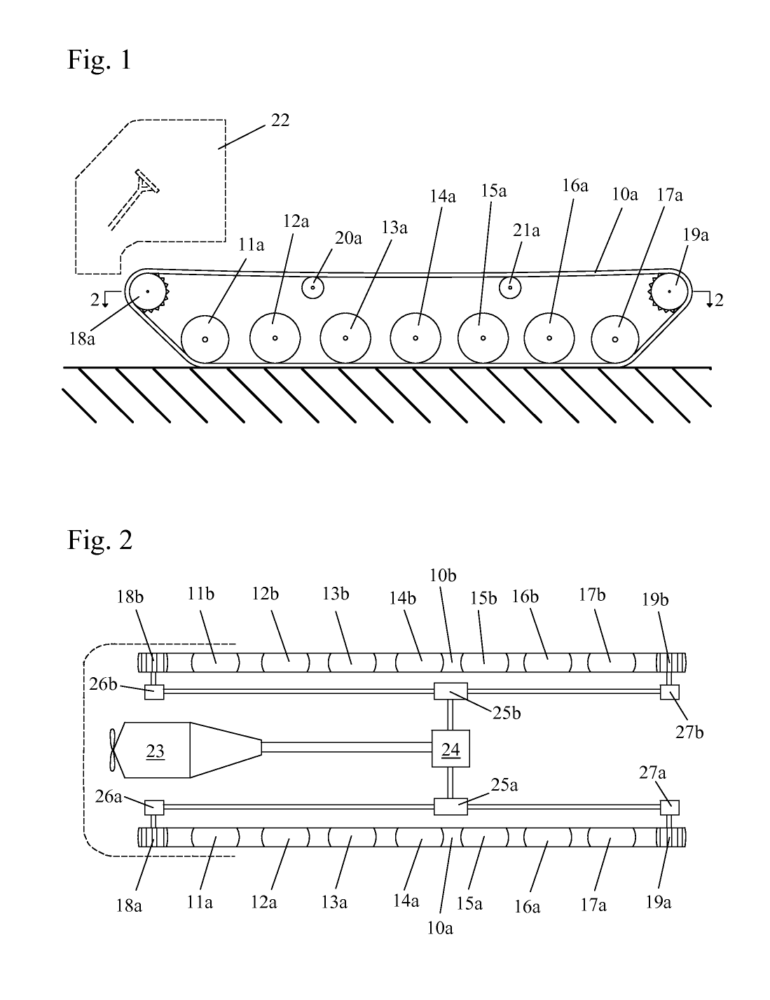

Referring to FIGS. 1 and 2, the tracked vehicle includes a left-side track 10a and a right-side track 10b. The loop of each track surrounds a respective plurality of at least three or more vehicle-supporting wheels 11a, 11b, 12a, 12b, 13a, 13b, 14a, 14b, 15a, 15b, 16a, 16b, 17a, 17b. Each wheel 11a, 11b, 12a, 12b, 13a, 13b, 14a, 14b, 15a, 15b, 16a, 16b, 17a, 17b is preferably conventionally mounted on a torsion bar suspension (not shown) that permits independent motion in a vertical plane. The tracks 10a, 10b are preferably positioned conventionally between each supporting wheel 11a, 11b, 12a, 12b, 13a, 13b, 14a, 14b, 15a, 15b, 16a, 16b, 17a, 17b and the terrain.

The upper portions of each track 10a, 10b are suspended above the upper surfaces of the respective vehicle-supporting wheels 11a, 11b, 12a, 12b, 13a, 13b, 14a, 14b, 15a, 15b, 16a, 16b, 17a, 17b by means of front drive sprockets 18a, 18b and rear drive sprockets 19a, 19b. Small idler rollers 20a, 21a, are positioned beneath the upper portions of each track 10a, 10b to provide additional support for slack in that portion of the track. A cabin 22 is indicated schematically to show the front of the tracked vehicle.

In the embodiment illustrated in FIG. 2, the drive torque developed by the vehicle engine/transmission 23 is delivered to a steer-drive mechanism 24 that divides the torque between left and right drives, the left drive being delivered to a left-track differential 25a and the right drive being delivered to a right-track differential 25b. The steer-drive mechanism 24 may be any mechanism which divides engine torque between the left track and the right track, such as, for example, a brake-steering mechanism or a drive differential, which may be a conventional open drive differential or a limited-slip differential. Each respective track differential 25a, 25b further divides the drive torque between the respective associated drive sprockets, namely, the left-track differential 25a delivers the further divided drive torque, respectively, to the front drive sprocket 18a through the right-angle box 26a and to the rear drive sprocket 19a through the right-angle box 27a. Similarly, the right-track differential 25b delivers the further divided drive torque, respectively, to the front drive sprocket 18b through the right-angle box 26b and to the rear drive sprocket 19b through the right-angle box 27b.

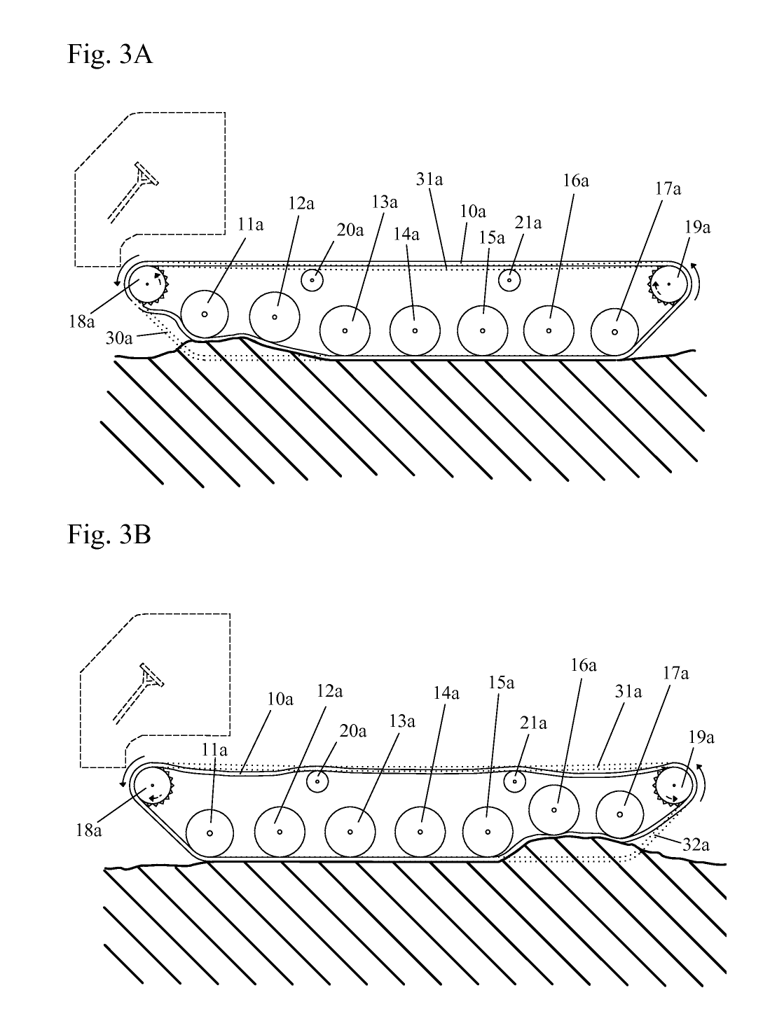

FIGS. 3A and 3B schematically illustrate operation of the vehicle shown in FIGS. 1 and 2 over uneven terrain when travelling in a forward direction, as indicated by the solid arrows outside the drive sprockets 18a and 19a.

In FIG. 3A, the front portion of the track 10a is moving over raised terrain, causing the front support wheels 11a, 12a to move upward vertically relative to the other wheels 13a, 14a, 15a, 16a, 17a. This raised terrain results in the loosening of the track 10a around the raised wheels 11a, 12a, since the track 10a is extended less than its normal distance 30a, shown in dotted lines. This loosening of the track momentarily provides less resistance that allows the front drive sprocket 18a to move slightly faster so that, due to differential action, the rear drive sprocket 19a moves slightly slower. These relative momentary movements are superimposed on the continuing forward rotations of each sprocket, as indicated, respectively, by the dotted arrows shown within each sprocket. These relative speed changes are permitted by the action of the left-track differential 25a. This differential action between the speeds of the drive sprockets causes a momentary shortening in the amount of track 10a stretched between the front drive sprocket 18a and the rear drive sprocket 19a, thereby tautening the track 10a and causing it to rise above the support rollers 20a, 21a, rather than in its normal position 31a, shown in dotted lines.

In FIG. 3B, the vehicle is again travelling in a forward direction, shown by the solid arrows outside drive sprockets 18a, 19a, but the rear portion of track 10a is moving over raised terrain, causing the rear support wheels 16a, 17a to move upward vertically relative to the other wheels 11a, 12a, 13a, 14a, 15a. Again, this alteration in terrain results in the loosening of the track 10a, since the track 10a is once again extended less than its normal distance 32a, shown in dotted lines. This loosening of the track again provides less resistance that, in this instance, allows the rear drive sprocket 19a to move slightly faster and the front drive sprocket 18a to move, differentially, slightly slower. Again, these relative momentary movements are superimposed on the continuing forward rotations of each sprocket, as indicated, respectively, by the dotted arrows shown within each sprocket.

However, this latter differential action, as different from that occurring in FIG. 3A, causes a momentary lengthening in the amount of track 10a stretched between the drive sprockets 18a and 19a, thereby loosening the track 10a and allowing it to drape in catenaries between the support rollers 20a and 21a, rather than in its normal position 31a, shown in dotted lines.

The relatively minor alterations in the relative speeds of the drive sprockets 18a and 19a, as permitted by the differential 25a, maintain a substantially optimum wrap of track 10a around the sprockets and significantly reduce the magnitude of spike-like forces that are borne by the track 10a and drive sprockets 18a and 19a from the momentary loosening and tightening of the track in response to variations in the terrain. Further, the drive divides the drive torque between the two drive sprockets 18a, 19a, thereby halving the amount of torque that must be supported by each sprocket. Also, the drive torque and the spike-like forces generated by the momentary loosening and tightening of the track in response to variations in the terrain are all shared between the more numerous teeth of the two drive sprockets. Thus, this division of the drive and shock loads between the more numerous teeth of the two drive sprockets results in significant reductions in the respective loads that must be borne by the track lugs, thereby significantly reducing track wear and increasing track life.

As indicated above, some possible further operational redundancy may be achieved in other embodiments of the invention, where the drive differential 24 and/or the track differentials 25a, 25b are limited-slip differentials. For heavier vehicles, all-gear limited-slip differentials with crossed-axes (e.g., IsoTorque® differentials, such as disclosed in U.S. Pat. No. 6,783,476) are preferred. With such limited-slip differentials, should one entire track become mired and begin to slip while the other track has traction, the track with fraction continues to drive the vehicle. Alternatively, should either of the pair of drive sprockets 18a, 19a or 19a, 19b become damaged and begin to slip, the other drive sprocket may still be sufficiently operational to provide some vehicle movement.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A drive for a tracked vehicle that is supported by at least one pair of left and right tracks, each track being associated with at least three individual wheels, each wheel being separately and independently movable in a vertical plane, and said vehicle having a drive train for delivering a divided drive torque from an engine to a respective drive unit associated with each said respective track, each said respective drive unit comprising:
at least two drive sprockets operatively connected to said track, each drive sprocket being connected at a respective position on said track that is remote from the position of the other drive sprocket; and
a track differential for receiving said divided drive torque delivered from said drive differential and further dividing said divided drive torque between said drive sprockets operatively connected to said track.

2. The drive of claim 1, wherein said drive sprockets are positioned in the vicinity of the front and rear of the track.

3. The drive of claim 1, wherein each track differential is an open differential.

4. The drive of claim 1, wherein each track differential is an all-gear limited-slip differential.

5. The drive of claim 1, wherein said drive train comprises a drive differential.

6. The drive of claim 5, wherein said drive differential is an all-gear limited-slip differential.

7. The drive of claim 5, wherein said drive differential is an all-gear limited-slip differential and each track differential is an all-gear limited-slip differential.

8. A drive for a tracked vehicle that is supported by a left track and a right track, each track being associated with at least three individual wheels, each wheel being separately and independently movable in a vertical plane, and said vehicle having a drive train for delivering a left divided drive torque from an engine to a left drive unit associated with said left track and a right divided drive torque to a right drive unit associated with said right track, said drive units further comprising:
a left forward drive sprocket operatively connected to said left track, said left forward drive sprocket being connected at a left forward position of said left track;
a left rearward drive sprocket operatively connected to said left track, said left rearward drive sprocket being connected at a rearward position on said left track that is remote from the position of the left forward drive sprocket;
a right forward drive sprocket operatively connected to said right track, said right forward drive sprocket being connected at a right forward position of said right track;
a right rearward drive sprocket operatively connected to said right track, said right rearward drive sprocket being connected at a rearward position on said right track that is remote from the position of the right forward drive sprocket;
a left track differential for receiving said left divided drive torque and further dividing said left divided drive torque between said left forward drive sprocket and said left rearward drive sprocket operatively connected to said left track, and
a right track differential for receiving said right divided drive torque and further dividing said right divided drive torque between said right forward drive sprocket and said right rearward drive sprocket operatively connected to said right track.

9. The drive of claim 8, wherein said left forward drive sprocket is positioned in the vicinity of the front of the left track, said left rearward drive sprocket is positioned in the vicinity of the rear of the left track, said right forward drive sprocket is positioned in the vicinity of the front of the right track, said right rearward drive sprocket is positioned in the vicinity of the rear of the right track.

10. The drive of claim 8, wherein said left track differential is an open differential and said right track differential is an open differential.

11. The drive of claim 8, wherein said left track differential is an all-gear limited-slip differential and said right track differential is an all-gear limited-slip differential.

12. The drive of claim 8, wherein said drive train comprises a drive differential.

13. The drive of claim 12, wherein said drive differential is an all-gear limited-slip differential.

14. The drive of claim 12, wherein said drive differential is an all-gear limited-slip differential, said left track differential is an all-gear limited-slip differential, and said right track differential is an all-gear limited-slip differential.
